(19) United States
(12) Patent Application Publication
(10) Pub. No.: US 2009/0193064 A1
(43) Pub. Date: Jul. 30, 2009

(54) METHOD AND SYSTEM FOR ACCESS-RATE-BASED STORAGE MANAGEMENT OF CONTINUOUSLY STORED DATA

(76) Inventors: Ying CHEN, Beijing (CN); Jie Chen, Beijing (CN); Liang Liu, Beijing (CN); Zhen Liu, Beijing (CN); Xue Feng Tang, Beijing (CN); Hao Wang, Beijing (CN); Bo Yang, Beijing (CN)

Correspondence Address: LAW OFFICE OF IDO TUCHMAN (YOR), ECM #72212, PO Box 4668, New York, NY, 10163-4668, US

(21) Appl. No.: 12/361,670

(22) Filed: Jan. 29, 2009

(30) Foreign Application Priority Data
Jan. 29, 2008 (CN) 200810009228.1

(51) Int. Cl. G06F 17/30

(52) U.S. Cl. 707/204; 707/E17.009

(57) ABSTRACT

A method and system for access-rate-based storage management of continuously stored data are provided, the method comprising the steps of: deciding an access weight dependent on an access rate for a data snapshot at a time point in continuously stored data stored in a storage system; determining whether the access weight reaches a first threshold and whether a full copy of the data snapshot at the time point is present in the storage system; and, storing a full copy of the data snapshot at the time point into the storage system when the access weight reaches the first threshold and a full copy of the data snapshot at the time point is absent from the storage system.

### CROSS-REFERENCE TO RELATED APPLICATIONS

This application claims priority under 35 U.S.C. §119 to Chinese Patent Application No. 200810009228.1 filed Jan. 29, 2008, the entire text of which is specifically incorporated by reference herein.

### BACKGROUND OF THE INVENTION

1. Field of the Invention

The present invention relates to the data processing field, particularly to the data storage and management field, and more particularly to a method and system for access-rate-based storage management of continuously stored data.

2. Description of Background

Companies with a strong consumer focus such as retail, financial, communication and marketing organizations, often need to explore stored business data (usually large amounts of data and typically business or market related data) in search of consistent patterns and/or systematic relationships between variables, and then to validate the findings by applying the detected patterns to new subsets of data and predict based thereon what will happen in the future.

For problem determination, impact analysis and change management in the IT system management field, it is often required to explore data stored in a change and configuration management database (CCMDB) to search for consistent patterns and/or systematic relationships between configuration items (CIs) and then to validate the findings by applying the detected patterns to new subsets of data and predict based thereon what will happen in the future.

In other fields where it is required to continuously monitor, collect and store or backup or archive data, the continuously stored data usually also needs to be accessed frequently so as to be analyzed and evaluated, etc.

Such requirements bring a challenge of how to quickly get the needed data with computing resources and time as little as possible. Current data storage management and accessing technologies can not deal with the challenge effectively because of their limitations.

For example, in a large scale business data center, its historical data are often backed up and archived according security and other policies, and these backed up and archived data need to be accessed by business intelligent analysis data software frequently. Table 1 lists several existing common data backup methods that can be used for storing and/or backing up historical data of a large scale business data center, for example, and the characteristics thereof.

TABLE 1
Common Backup Methodologies

| Common Backup | | |
|---|---|---|
| Methodologies | How it works | Characteristics |
| Full backup | Every file on a | Large amounts of |
| | given computer | data need to be |
| | or file system | moved. It is |
| | is copied | generally not |
| | whether or not | feasible in a |
| | it has changed | networked |
| | since the last | environment |
| | backup | |
| Full + incremental | Full backups | Less data need |
| backup | are performed | to be moved than |
| | on a regular | in a Full |
| | basis, for | backup. Only the |
| | example, weekly | latest |
| | In between Full | incremental copy |
| | backups, | is restored. |
| | regular | |
| | incremental | |
| | backups copy | |
| | only files that | |
| | have changed | |
| | since the last | |
| | backup | |
| Full + | Full backups | Better restore |
| differential | are performed | performance than |
| backup | on a regular | in a |
| | basis, for | Full + Incremental |
| | example, weekly | backup. But the |
| | In between Full | differential |
| | backups, | backup scheme |
| | differential | will back up |
| | backups copy | more data |
| | only files that | because it |
| | have changed | ignores |
| | since the last | differentials |
| | Full backup | that were taken |
| | | between the |
| | | previous full |
| | | and the current |
| | | differential. |
| Progressive backup | A full backup | Entirely |
| | is performed | eliminates |
| | only once | redundant data |
| | After the full | backups |
| | backup, | Tivoli Storage |
| | incremental | Manager |
| | backups copy | automatically |
| | only files that | releases expired |
| | have changed | file space to be |
| | since the last | overwritten; |
| | backup | this reduces |
| | Metadata | operator |
| | associated with | intervention and |
| | backup copies | the chance of |
| | is recorded in | accidental |
| | a database such | overwrites of |
| | as the Tivoli | current data |
| | Storage | Over time, less |
| | Manager. The | data need to be |
| | number of | moved than in |
| | backup copies | Full + |
| | stored and the | Incremental or |
| | length of time | Full + |
| | they are | Differential |
| | retained are | backups, and |
| | specified by a | data restoration |
| | storage | is mediated by |
| | administrator | the database |

It can be seen from the above table that the scheme of full backup at each time point is rarely adopted since it needs to occupy excessive storage space and network bandwidth. Most existing backup schemes adopt a certain form of full+differential backup, no matter whether this kind of full backup is executed only once or periodically, and no matter whether this kind of differential backup is executed with respect to the previous full backup or the previous differential backup. Although such a solution of full+differential backup saves storage space and network bandwidth for transmitting data, when the data at a certain time point needs to be restored, the complete data snapshot at the time point usually needs to be reconstructed based on the differential backup at the time point and the full backup before the time point (as well as the differential backups therebetween), thus needing to occupy more calculation resources and a longer data restoring time. So in case that backup data needs to be accessed frequently, such a solution of full+differential backup is not applicable.

The same problem exists in the CCMDB system. The storage and management of the data of configuration etc. in the CCMDB system is similar to the backup mechanism in a storage management system, and is also based on differential storage, that is, the full data at a certain time point are stored and data stored subsequently are all differential data based on the full data. Thus, if it is needed to access the data at a certain time point, a reconstruction calculation needs to be performed based on the differential data at the time point and the full data before the time point, so as to obtain the full data at the time point for use, thus needing to occupy more calculation resources and time. Since the data in the CCMDB system are the core data for the whole IT management, and need to be accessed frequently according to management and application requirements, the overhead of the data storage and management scheme in the existing CCMDB system is high, thus severely affecting the efficiency and effect of the whole IT management.

Obviously, there is needed in the art a storage management and access solution for continuously stored data in a backup system and a CCMDB system, for example, which enables fast restoration and access of data.

### BRIEF SUMMARY OF THE INVENTION

In order to enable fast restoration and access of continuously stored data in a backup system and a CCMDB system, for example, and enhance the performance and efficiency of a data storage management and access system, the present invention is proposed.

According to one aspect of the present invention, there is provided a method for access-rate-based storage management of continuously stored data, comprising the steps of: deciding an access weight dependent on an access rate for a data snapshot at a time point in continuously stored data stored in a storage system; determining whether the access weight reaches a first threshold and whether a full copy of the data snapshot at the time point is present in the storage system; and, storing a full copy of the data snapshot of the time point into the storage system when the access weight reaches the first threshold and a full copy of the data snapshot at the time point is absent from the storage system.

According to another aspect of the present invention, there is provided a system for access-rate-based storage management of continuously stored data, comprising a cache manager including a means for deciding an access weight dependent on an access rate for a data snapshot at a time point in continuously stored data stored in a storage system; a means for determining whether the access weight reaches a first threshold and whether a full copy of the data snapshot at the time point is present in the storage system; and, a means for storing a full copy of the data snapshot at the time point into the storage system when the access weight reaches the first threshold and a full copy of the data snapshot of the time point is absent from the storage system.

The present invention can be applied to all cases in which data are stored and managed in the form of full copy+differential copy, and the data need to be accessed frequently for use, whether for the storage and utilization of user business historical data or in the CCDMB field, enabling fast access to, as well as analysis and utilization of large amounts of data, and greatly saving computing and network resources.

### BRIEF DESCRIPTION OF THE SEVERAL VIEWS OF THE DRAWINGS

The attached claims describe novel features believed to be characteristic of the present invention. However the invention itself and its preferred embodiments, additional objects and advantages can be best understood from the following detailed description of illustrative embodiments when read in conjunction with the drawings, in which:

FIG. 1 shows a system for access-rate-based storage management of continuously stored data according to an embodiment of the present invention;

FIG. 2 shows an exemplary structure of a metadata base according to one embodiment of the present invention;

FIG. 3 shows the status of the storage system before the system according to an embodiment of the present invention performs operations according to an embodiment of the present invention;

FIG. 4 shows the status of the storage system after the system according to an embodiment of the present invention performs operations according to an embodiment of the present invention; and

FIG. 5 shows a method for access-rate-based storage management of continuously stored data according to an embodiment of the present invention.

### DETAILED DESCRIPTION OF THE INVENTION

The present invention relates to the dynamic adjustment of the storage form of continuously stored data (having or not having a certain schema or relation constraints) in a storage device. According to the original storage policy of the storage device, the snapshot of accessed data at a certain time is restored from the storage device for use by the accessor, and at the same time the restored snapshot of the accessed data is placed in an access cache. Afterwards, if the data snapshot is accessed, the data snapshot in the access cache is provided to the accessor, and at the same time, the frequency or weight at which the data snapshot is accessed is monitored and recorded. When the frequency or weight at which the data snapshot is accessed exceeds a certain threshold, the storage form of the accessed data in the storage device is adjusted to store the data in the form of full backup, and further the storage of the data on the storage medium after the this time may be adjusted correspondingly based on the full copy of the data, according to the storage policy of the storage device, thus increasing the speed for storage access and lowing the overhead for storage access.

Embodiments of the present invention will be explained hereinafter. However, it should be noted that the present invention is not limited to particular embodiments described herein. On the contrary, it is contemplated to implement and practice the present invention using any combination of the following features and elements, regardless of whether they involve different embodiments. Therefore, the following aspects, features, embodiments and advantages are only used for illustration and should not be regarded as the elements or definitions of the attached claims, unless indicated otherwise explicitly in the claims.

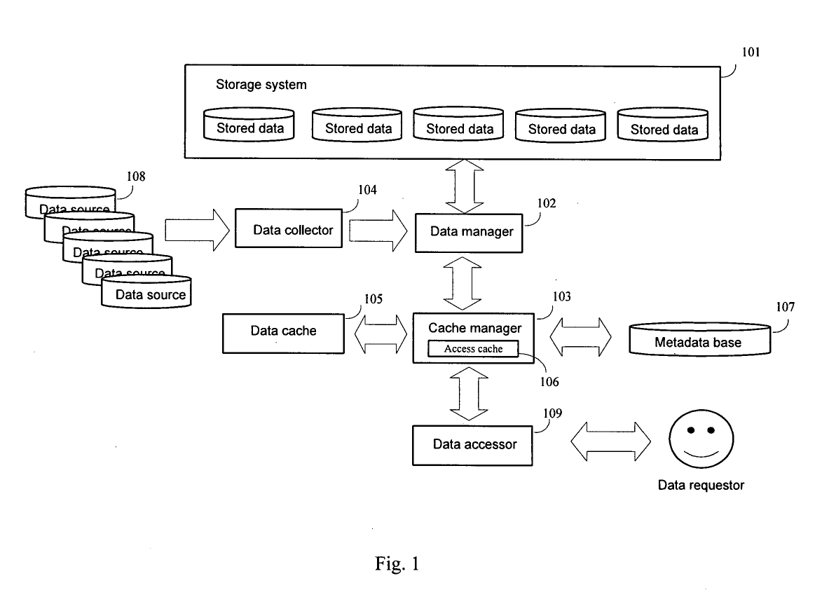

FIG. 1 shows a system for access-rate-based storage management of continuously stored data according to an embodiment of the present invention. As shown in the figure, the system comprises a storage system 101, a data manager 102 and a cache manager 103.

The storage system 101 is for storing and/or backing up data. The storage system 101 can be any storage system and/or backup system as known in the art, and preferably can be configured to store data in the form of full copy+differential copy, such as Tivoli Storage Manager of the IBM corporation. The storage system 101 can adopt various storage policies, and preferably the storage policies are configurable. According to different storage policies, the storage system 101 can either store a full copy at an initial time point, or store a plurality of full copies at a plurality of time points periodically or in other ways. The differential copy can be either with respect to a full copy at the initial time point or the previous time point, or with respect to a differential copy at the previous time point. In addition, herein, storage should be understood as also including backup.

The data are preferably continuously monitored, obtained and stored data, such as CCMDB data comprising continuously monitored configuration, log and performance information, and continuously generated and stored business data of an enterprise comprising customer, marketing, sales and other information, etc.

The data manager 102 is for accessing the storage system 101, and for storing, adjusting and restoring data snapshots through the storage system 101 according to a data storing method and a storage policy. Specifically, after receiving data obtained by a data collector 104 as described below, the data manager 102 can provide the data to the storage system 101 to be stored in a permanent storage in the storage system 101. When receiving from the cache manager 103 a request for loading a data snapshot at a certain time point from the storage system 101, the data manager 102 can obtain or restore a full copy of the data snapshot at the time point from the permanent storage of the storage system 101 (for example, reconstruct and restore a full copy of the data snapshot at the time point using the differential copy of the data snapshot at the time point and a full copy of a data snapshot at a previous time point), and provide it to the cache manager 103. When receiving from the cache manager 103 a request for storing a full copy of a data snapshot at a certain time point in the storage system 101, the data manager 102 can store the full copy of the data snapshot at the time point into the permanent storage of the storage system 101, so that when afterwards receiving from the cache manager 103 a request for loading the data at the time point, the data manager 102 can directly provide the full copy of the data snapshot at the time point stored in the permanent storage of the storage system 101 to the cache manager 103, instead of reconstructing and restoring a full copy of the data snapshot at the time point using the differential copy of the data snapshot at the time point and a full copy of a data snapshot at a previous time point. In addition, after the data manager 102 has stored a full copy of a snapshot at a certain time point into the permanent storage of the storage system 101 according to the request from the cache manager 103, the data manager 102 can further adjust the storage of the data after the time point in the storage system 101 based on the full copy of the data snapshot at the time point and a preset storage policy, that is, making the differential data after the time point based on the full copy of the data snapshot at the time point instead of the full copy of a data snapshot at a certain previous time point.

The data manager 102 can be either a component external to the storage system 101, or part of the storage system 101. The data manager 102 can be either any existing component that can interact with the storage system 101 to store, adjust and restore data snapshots in the permanent storage, or a component established according to the present invention.

The cache manager 103 is for managing an access cache 106, receiving a request for accessing a data snapshot at a time point in the continuously stored data stored in the storage system 101, and then determining whether a full copy of the data snapshot at the time point that is requested to be accessed is present in the access cache 106. When determining a full copy of the data snapshot at the time point that is requested to be accessed is present in the access cache 106, the cache manager 103 can serve the access request using the full copy of the data snapshot at the time point in the access cache 106, i.e., send the full copy of the data snapshot to the requester. When determining a full copy of the data snapshot at the time point that is requested to be accessed is absent from the access cache, the cache manager 103 can obtain or restore a full copy of the data snapshot at the time point stored in the storage system 101 through the data manager 102, load it into the access cache 106, and serve the access request using the loaded full copy of the data snapshot at the time point. Thus, when afterwards the cache manager 103 receives a request for accessing the data snapshot at the time point again, it can serve the access request by directly using the full copy of the data snapshot at the time point cached in the access cache 106, until the full copy of the data snapshot at the time point cached in the access cache 106 is removed.

In a further embodiment of the present invention, the cache manager 103 is further for managing a data cache 105. After receiving a request for accessing a data snapshot at a time point in the continuously stored data stored in the storage system 101, the cache manager 103 can determine whether a full copy of the data snapshot at the time point which is requested to be accessed is present in the access cache 106. When determining a full copy of the data snapshot at the time point which is requested to be accessed is absent from the access cache 106, the cache manager 103 can further determine whether a full copy of the data snapshot at the time point which is requested to be accessed is present in the data cache 105. When determining a full copy of the data snapshot at the time point which is requested to be accessed is present in the data cache 105, the cache manager 103 can obtain the full copy of the data snapshot at the time point from the data cache 105, load it into the access cache 106, and at the same time serve the access request using the full copy of the data snapshot at the time point. When determining a full copy of the data snapshot at the time point that is requested to be accessed is absent from the data cache 105, the cache manager 103 can restore and load a full copy of the data snapshot at the time point from the storage system 101 through the data manager 102 as described above. Thus, when afterwards receiving again a request for accessing the data snapshot at the time point, the cache manager 103 can serve the access request using directly the full copy of the data snapshot at the time point cached in the access cache 106, until the full copy of the data snapshot at the time point cached in the access cache 106 is removed.

The cache manager 103 is further for monitoring and counting the requests for accessing the data snapshot at a time point, and calculating an access weight dependent on the access rate for the data snapshot at the time point. The cache manager 103 can further determine whether the access weight for the data snapshot at a certain time point reaches a first threshold and whether a full copy of the data snapshot at the time point is present in the storage system 101. When determining the access weight for the data snapshot at the time point reaches a first threshold and a full copy of the data snapshot at the time point is absent from the storage system 101, the cache manager 103 can store a full copy of the data snapshot at the time point into the storage system 101. Thus, when afterwards receiving again a request for accessing the data snapshot at the time point, the cache manager 103 can directly obtain a full copy of the data snapshot at the time point from the storage system 101, instead of reconstructing and restoring a full copy of the data snapshot at the time point using a differential copy of the data snapshot at the time point and a full copy of a data snapshot at a previous time point (and the differential copies at other time points therebetween).

In a further embodiment of the present invention, after calculating an access weight dependent on the access rate for the data snapshot at a time point, the cache manager 103 can further determine whether the access weight for the data snapshot at the time point reaches a second threshold and whether a full copy of the data snapshot at the time point is present in the data cache 105. When determining the access weight for the data snapshot at the time point reaches the second threshold and a full copy of the data snapshot at the time point is absent from the data cache 105, the cache manager 103 can store a full copy of the data snapshot at the time point into the data cache 105. Thus, thereafter when receiving again a request for accessing the data snapshot at the time point, the cache manager 103 can directly obtain the full copy of the data snapshot at the time point from the data cache 105, instead of obtaining a full copy of the data snapshot at the time point from the storage system 101. In an embodiment of the present invention, the first threshold is a lower threshold and the second threshold is a higher threshold.

The cache manager 103 can calculate the access weight in a various ways. In an embodiment of the present invention, the access weight is equal to the access rate, i.e., the number of accesses to the data snapshot at a certain time point during a certain period.

The cache manager 103 can store full copies of one or more data snapshots in the access cache 106. The cache manager 103 can remove from the access cache 106 the full copies of the data snapshots the accesses to which do not reach the first threshold and the second threshold during a set time period; and the cache manager 103 can also remove the full copies of the data snapshots whose access weights are lower in the access cache 106 periodically; or the cache manager 103 can also remove the existing full copies of the data snapshots at the time points whose access weights are lower when the access cache 106 is full or is being loaded with full copies of new data snapshots.

The cache manager 103 preferably stores full copies of a plurality of snapshots in the data cache 105. The cache manager 103 removes periodically the full copies of the data snapshots whose access weights are lower in the data cache 105; or the cache manager 103 can also remove the full copies of the data snapshots whose access weights are lower when the data cache 105 is full or is being loaded with full copies of new data snapshots.

The access cache 106 and the data cache 105 can be various types of storing devices. The access cache 106 can be a volatile or nonvolatile storing device. The data cache 105 is preferably a nonvolatile storing device.

Although the access cache 106 is shown to be located inside the cache manager 103 while the data cache 105 is shown to be located outside the cache manager 103, this is not a limitation to the present invention. Both the access cache 106 and the data cache 105 can be located either inside the cache manager 103, or outside the cache manager 103.

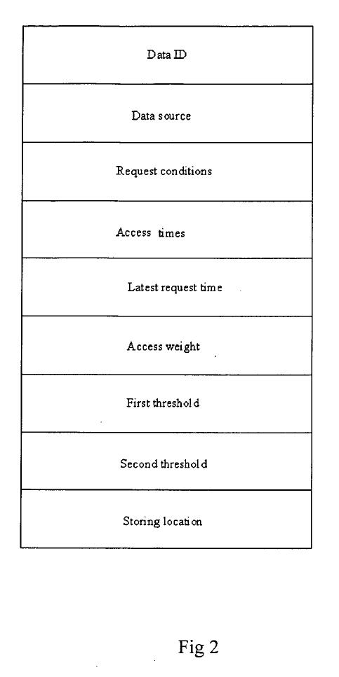

In an embodiment of the present invention, the cache manager 103 maintains in a metadata base 107 the access rate, the access weight, the first threshold and/or the second threshold, and the storing location information of the data snapshot at the time point. FIG. 2 shows an exemplary structure of the metadata base 107 according to an embodiment of the present invention. As shown in the figure, the metadata base 107 includes data ID, data source, request conditions, access times, latest request time, access weight, first threshold, second threshold and storing location. The data ID is used to identify data which are stored in the storage system 101 and managed by the system of the present invention, and whose information is recorded in the metadata base 107; the data source represents the source of the data; the request conditions represent the conditions for requesting access to the data, such as the time point at which the data requested to be accessed are or the time period to which the data requested to be accessed belong, as well as any other conditions; the access times represents the number of times of accesses to the data; the latest request time represents the time at which the data are accessed last time; the access weight is a measure related to the frequency at which the data are accessed, and is equal to the number of accesses in a given period in an embodiment of the present invention; the first threshold is a criterion for determining whether a full copy of the data should be stored in the storage system 101; the second threshold is a criterion for determining whether a full copy of the data should be stored in the data cache 105; and the storing location represents the location where a full copy of the data is stored, such as the data cache 105 or the storage system 101. The above metadata base structure is only an illustration instead of a limitation to the present invention. There can be more, less and different information items in the metadata base structure according to embodiments of the present invention. For example, the metadata base 107 can have a plurality of information items of storing location so as to represent whether a full copy of a data snapshot at a certain time point is present in the access cache 106, the data cache 105 and the storage system 101, respectively. In addition, the metadata base 107 can be located at any position or storing device that can be accessed by the cache manager 103.

In an embodiment of the present invention, the system for access-rate-based storage management of continuously stored data performs the above operations according to the information in the metadata base 107, and records and updates the information in the metadata base during the performing of the above described operations.

For example, when receiving a request for accessing the data snapshot at a time point in the storage system 101, the cache manager 103 can determine whether the metadata base 107 contains the information of the data snapshot at the time point by querying the metadata base 107.

If determining the metadata base 107 does not contain the information of the data snapshot at the time point, then the cache manager 103 can reconstruct and restore a full copy of the data snapshot at the current time point through the data manager 102 according to the storage policy of the storage system 101 by using a full copy of a data snapshot at the previous time point stored in the storage system 101 and a differential copy of the data snapshot at the current time point (and differential copies of the data snapshots at one or more time points therebetween), load it into the access cache 106, and serve the data request using the loaded full copy of the data snapshot at the time point. At the same time, the cache manager 103 can create an entry regarding the data snapshot at the time point in the metadata base 107, and add such information as the data ID, data source, request conditions, access times, latest request time, access weight, first threshold, second threshold and storing location for the data snapshot.

If determining that the metadata base 107 contains the information of the data snapshot at the time point, then the cache manager 103 further determines whether a full copy of the data snapshot at the time point is stored in the access cache 106 by querying the corresponding information items in the metadata base 107.

If determining a full copy of the data snapshot at the time point is stored in the access cache 106, the cache manager 103 serves the data access request be directly using the full copy of the data snapshot at the time point in the access cache 106, and at the same time updates such information as the access times, access weight and latest request time in the metadata base. Then the cache manager 103 determines whether the updated access weight exceeds the first threshold stored in the metadata base 107 and whether a full copy of the data snapshot at the time point is present in the storage system 101 based on the corresponding information item in the metadata base 107, and when the updated access weight exceeds the first threshold and a full copy of the data snapshot at the time point is absent from the storage system 101, stores a full copy of the data snapshot at the time point into the storage system 101 through the data manager 102, and at the same time updates the corresponding information item of storing location in the metadata base 107. In addition, the cache manager 103 can further determine whether the updated access weight exceeds the second threshold stored in the metadata base 107, and determine whether a full copy of the data snapshot at the time point is present in the data cache 105 according to the corresponding information items in the metadata base 107, and when the updated access weight exceeds the second threshold and a full copy of the data snapshot at the time point is absent from the data cache 105, store the full copy of the data snapshot at the time point into the data cache 105 and at the same time update the corresponding information item of storing location in the metadata base 107.

If determining a full copy of the data snapshot at the time point is absent from the access cache 106, the cache manager 103 further determines whether a full copy of the data snapshot at the time point is present in the data cache 105 by querying the corresponding information items in the metadata base 107. If determining a full copy of the data snapshot at the time point is present in the data cache 105, the cache manager 103 loads into the access cache 106 the full copy of the data snapshot at the time point from the data cache 105, serves the data access request using the full copy of the data snapshot at the time point, and at the same time updates such information as the access times, access weight, latest access time and storing location in the metadata base.

If determining a full copy of the data snapshot at the time point is both absent from the access cache 106 and absent from the data cache 105, the cache manager 103 further determines whether a full copy of the data snapshot at the time point is present in the storage system 101 by querying the corresponding information items in the metadata base 107. If determining a full copy of the data snapshot at the time point is present in the storage system 101, then the cache manager 103 loads into the access cache 106 the full copy of the data snapshot at the time point from the storage system 101 through the data manager 102, serves the data access request using the full copy of the data snapshot at the time point, and at the same time updates such information as the access times, access weight, latest access time and storing location in the metadata base 107. In addition, the cache manager 103 can further determine whether the updated access weight reaches the second threshold stored in the metadata base 107, and when determining the updated access weight reaches the second threshold stored in the metadata base 107, further store the full copy of the data snapshot at the time point into the data cache 105, and update the corresponding information item of storing location in the metadata base. On the other hand, if determining a full copy of the data snapshot at the time point is absent from the storage system 101, the cache manager 103 can reconstruct and restore a full copy of the data snapshot at the time point from a full copy of a data snapshot at the previous time point stored in the storage system 101 and a differential copy of the data snapshot at the current time point (and differential copies of the data snapshots at one or more time points therebetween) through the data manager 102 according to the storage policy of the storage system 101, load it into the access cache 106, and serve the data request using the loaded full copy of the data snapshot at the time point. At the same time, the cache manager 103 can update such information of the data snapshot as the access times, access weight, latest request time and storing location in the metadata base 107.

In an embodiment of the present invention, the system for access-rate-based storage management of continuously stored data further comprises a data collector 104 which is for collecting related data continuously from a data source and submitting the collected data to the data manager 102, to be stored into the storage system 101. Before the collected data are submitted to the data manager 102, the data collector can perform necessary screening, processing and conversion operations on the data. The data collector 102 can be any data collector as known in the art. The data collector 104 can collect data from either a single data source or from a plurality of different data sources.

In an embodiment of the present invention, the system for access-rate-based storage management of continuously stored data further comprises a data accessor 109, through which a user accesses the cache manager 103. The data accessor 109 can be either any existing data accessor that can be used for accessing cache manager, or a data accessor created according to the present invention. In addition, the data accessor 109 either can be a component external to the cache manager 103, or can be incorporated into the cache manager. In addition, the data accessor 109 can also be part of the client at which the user is.

In some embodiments of the present invention, the system for access-rate-based storage management of continuously stored data can exclude the data collector 104 and the data accessor 109.

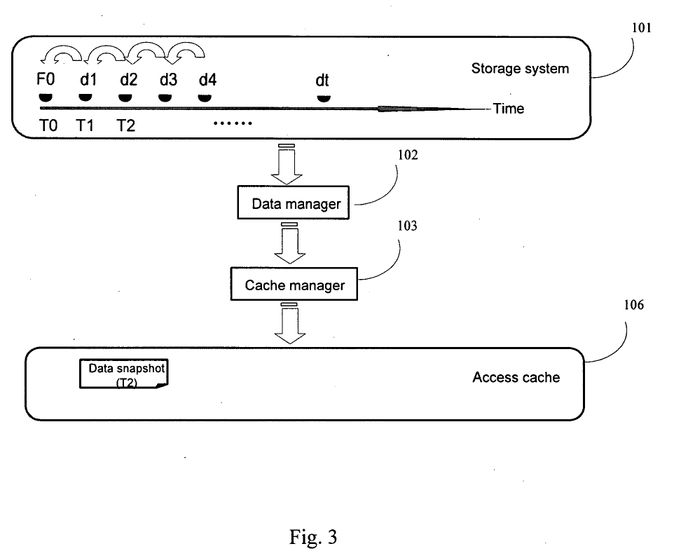

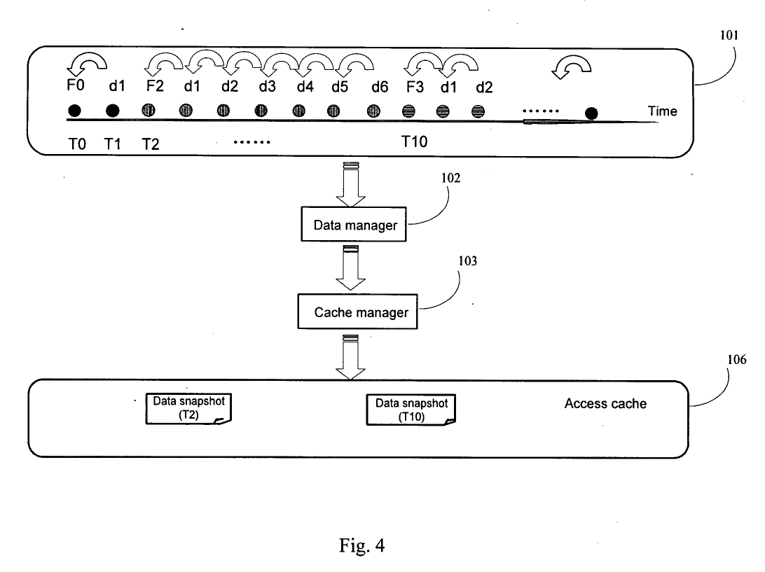

FIGS. 3 and 4 schematically illustrate the operation principles of the above described system for access-rate-based storage management of continuously stored data according to an embodiment of the present invention. FIG. 3 specifically illustrates the status of the storage system 101 before the system performs the operations according to an embodiment of present invention, and FIG. 4 specifically illustrates the status of the storage system 101 after the system performs the operations according to an embodiment of present invention. As shown in FIG. 3, before the system performs the operations according to the present invention, there are stored in the storage system 101 a full copy F0 of the data at time point T0 and differential copies d1 and d2, etc. of the data at the time points T1 and T2, etc. It can be seen from the figure that except for the full copy F0 stored at the time point T0, the differential copies d1 and d2, etc. stored at the other time points T1, T2 etc. are all based on the full copy or differential copy at the previous time point, that is, at the time points T1, T2, etc., only the change of the data between the time point and the previous time point is stored. In such a storing scheme, in order to restore the full data snapshots at the time points T1, T2 etc., the differential copy at the time point should be combined with the previous full copy and all the differential copies therebetween. FIG. 3 further shows a full copy of the data snapshot at time point T2 is stored in the access cache 106, which full copy is obviously reconstructed and restored by combining the differential copy d2 at time point T2 stored in the storage system 101 with the differential copy d1 at the previous time point T1 and the full copy at the time point T0.

As shown in FIG. 4, there are stored in the access cache 106 full copies of the data snapshots at time points T2 and T10, and since the number of accesses to the full copies of the data snapshots at time points T2 and T10 exceeds a predetermined threshold, the system according to the present invention stores in the storage system 101 full copies F2 and F3 of the data snapshots at time points T2 and T10, and at the same time adjusts the data storage form after time points T2 and T10 so that the differential copies after time points T2 and T10 are no longer based on the full copy at time point T0, but instead are based on the full copies at T2 and T10, respectively. Thus, in order to serve future accesses to the data snapshots at time points T2 and T10, the full copies of the data snapshots at time points T2 and T10 can be obtained directly from the storage system 101; and in order to serve future accesses to the data snapshots at the time points after time points T2 and T10, the full copies at the time points can be restored based on the full copies at the time points T2 and T10, respectively, instead of restoring the full copies of the data snapshots at the time points based on the full copy at time point T0.

A system for access-rate-based storage management of continuously stored data according to an embodiment of the present invention has been described above. It should be noted that the above description is only an illustration, instead of a limitation to the present invention. The system of the present invention can have more, less or different modules compared to that shown and described, and the relationships among the modules can also be different from those shown and described. For example, it is also contemplated that the cache manager 103 can be only for adjusting the storage form of data in the storage system 101 and/or the storage of data in the data cache 105 according to the access weight, without serving data access requests, and the system of the present invention can only include the cache manager 103 without including the storage system 101 and the data manager 102, and so on.

In addition, the various functions performed by the cache manager 103 can all be implemented as being performed by corresponding means included in the cache manager 103. For example, in an embodiment of the present invention, the cache manager 103 comprises a means for determining an access weight dependent on the access rate for a data snapshot at a time point in continuously stored data stored in a storage system; a means for deciding whether the access weight reaches a first threshold and whether a full copy of the data snapshot at the time point is present in the storage system; and, a means for storing a full copy of the data snapshot of the time point into the storage system when the access weight reaches the first threshold and a full copy of the data snapshot of the time point is absent from the storage system. In an embodiment of the present invention, the cache manager 103 further comprises a means for deciding whether the access weight reaches a second threshold and whether a full copy of the data snapshot of the time point is present in a data cache; and, a means for storing a full copy of the data snapshot of the time point into the data cache when the access weight reaches the second threshold and a full copy of the data snapshot of the time point is absent from the data cache. In a embodiment of the present invention, the cache manager 103 further comprises a means for receiving a request for accessing a data snapshot at a time point in continuously stored data stored in the storage system; and a means for serving the access request. And in an embodiment of the present invention, the means for serving the access request further comprises a means for determining whether the data snapshot at the time point which is requested to be accessed is present in an access cache; a means for obtaining or restoring a full copy of the data snapshot at the time point from the storage system and loading it to the access cache when the determination result is No; and a means for serving the request for accessing the data snapshot at the time point using the loaded full copy of the data snapshot at the time point. In another embodiment of the present invention, the means for serving the access request further comprises a means for determining whether the data snapshot at the time point that is requested to be accessed is present in an access cache; a means for further determining whether the data snapshot at the time point is present in the data cache when the determination result is No; a means for loading the full copy of the data snapshot at the time point from the data cache to the access cache when the further determination result is Yes; a means for obtaining or restoring a full copy of the data snapshot at the time point from the storage system and loading it into the access cache when the further determination result is No; and a means for serving the request for accessing the data snapshot at the time point by using the loaded full copy of the data snapshot at the time point.

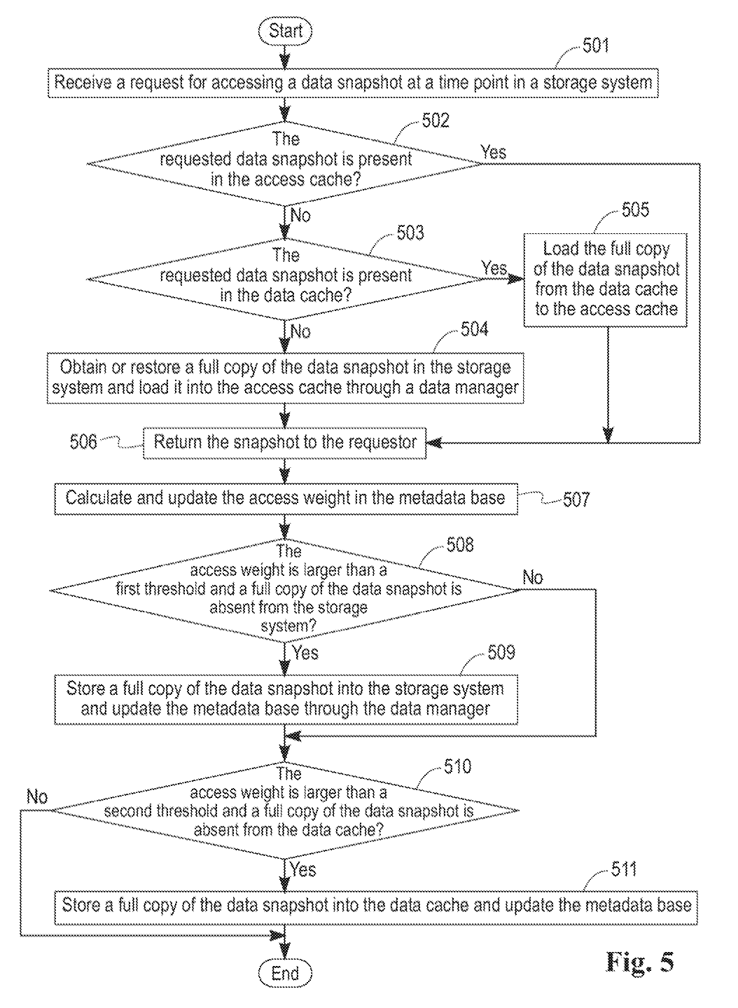

A method for access-rate-based storage management of continuously stored data according to an embodiment of the present invention will be described below with reference to FIG. 5.

As shown in the figure, at step 501, a request for accessing the data snapshot at a time point in continuously stored data stored in a storage system is received. The storage system can be any data storage and/or backup system as known in the art and preferably can be configured to store data in the form of full+differential copies.

At step 502, it is determined whether the data snapshot at the time point that is requested to be accessed is present in an access cache. When the determination result is No, the process proceeds to step 503, and when the determination result is Yes, the process proceeds to step 506.

At step 503, it is determined whether the data snapshot at the time point that is requested to be accessed is present in a data cache. When the determination result is Yes, the process proceeds to step 505, and when the determination result is No, the process proceeds to step 504.

At step 504, a full copy of the data snapshot at the time point in the storage system is obtained or restored by a data manager of the storage system, and is loaded into the access cache. That is, when the data snapshot at the time point in the storage system is present in the form of a full copy, the full copy is directly loaded into the access cache by the data manager; and when the data snapshot at the time point in the storage system is present in the form of a differential copy, the data manager reconstructs and restores a full copy of the data snapshot at the time point using the differential copy of the data snapshot at the time point and the full copy before the time point (and other differential copies between the differential copy and the full copy) according to the storage policy of the storage system, and loads the full copy into the access cache.

At step 505, the full copy of the data snapshot is loaded into the access cache form the data cache.

In an embodiment of the present invention, there are no steps 503 and 505. Thus when it is determined in step 502 that the data snapshot is absent from the access cache, the process proceeds directly to step 504.

At step 506, the full copy of the data snapshot at the time point is returned to the requester.

At step 507, an access weight is calculated and updated. The access weight is preferably stored in a metadata base. The metadata base stores information on the accessed data snapshots at various time points, such as the data sources, request conditions, latest access times, access times, access weights, first thresholds and second thresholds, etc. of the data snapshots at various time points. The access weight is calculated based on the access times, and in an embodiment of the present invention, the access weight is equal to the access times in a given period, i.e. the access rate. That is, at this step, the original access times in the metadata base will be extracted and incremented by 1 so as to obtain a new access times, based on which a new access weight is calculated, then the original access times and access weight are replaced with the new access times and access weight.

At step 508, it is determined whether the access weight reaches a first threshold and whether a full copy of the data snapshot at the time point is absent from the storage system. When determining the access weight reaches the first threshold and the full copy of the data snapshot at the time point is absent from the storage system, the process proceeds to step 509; when determining the access weight does not reach the first threshold or the full copy of the data snapshot at the time point is present in the storage system, the process proceeds to step 510. The first threshold is preferably stored in the metadata base.

At step 509, the full copy of the data snapshot at the time point is stored in the storage system through the data manager. At the same time, the information on the storing location of the data snapshot at the time point in the metadata base is updated. In an embodiment of the present invention, after storing the full copy of the data snapshot at the time point in the storage system, the storage form of the data snapshot after the time point needs to be adjusted. That is, the original differential copy based on the full copy of the data snapshot at a previous time point is replaced with a differential copy based on the full copy of the data snapshot at the time point, or a differential copy based on the full copy of the data snapshot at the time point is created in addition to the original differential copy based on the full copy of the data snapshot at the previous time point, or only when a new copy of a data snapshot at a time point after the time point needs to be stored, the differential copy of the data snapshot is stored based on the full copy at the time point according to the storage policy in the storage system.

At step 510, it is determined whether the access weight reaches a second threshold and whether a full copy of the data snapshot at the time point is absent from a data cache. When determining that the access weight reaches the second threshold and the full copy of the data snapshot at the time point is absent from the data cache, the process proceeds to step 511; and when determining the access weight does not reach the second threshold or the full copy of the data snapshot at the time point is present in the data cache, the process ends, thus completing the processing for the access request. The second threshold is preferably stored in a metadata base.

At step 511, a full copy of the data snapshot at the time point is stored in the data cache. At the same time, the information on the corresponding storing location of the data snapshot at the time point in the metadata base is updated.

In an embodiment of the present invention, there are no steps 510 and 511. Thus, when it is determined at step 508 the access weight does not reach the first threshold or the full copy of the data snapshot at the time point is already present in the storage system, or after storing the full copy of the data snapshot at the time point into the storage system at step 509, the process ends.

After the process ends, when receiving a new request for accessing a data snapshot at a time point in the storage system, the process can be repeated to process the new access request.

A method for access-rate-based storage management of continuously stored data according to an embodiment of the present invention has been described. It should be noted that the method shown and described is only an illustration instead of a limitation to the present invention. The method of the present invention can have more, less or different steps, and the order between some steps may be different from that shown and described, and can be executed in parallel. In addition, some steps shown and described can be merged into a larger step or divided into smaller steps. For example, steps 502-506 shown and described can be merged into one step, which can be referred to as a step for serving the data access request, and so on. These changes all fall into the scope of the present invention.

The present invention can be implemented in hardware, software, firmware or a combination thereof. The present invention can be implemented in a single computer system in a centralized manner or in a distributed manner in which various elements are distributed in a number of interconnected computer systems. Any computer system or other apparatus suitable for executing the methods described herein is applicable. Preferably, the present invention is implemented in the form of a combination of computer software and general computer hardware, where, when being loaded and executed, the computer program control the computer system to execute the method of the present invention, or constitute the system of the present invention.

While the present invention is shown and described with reference to the preferred embodiments particularly, a person skilled in the art can understand that various changes in form and detail can be made thereto without departing from the spirit and scope of the present invention.

That which is claimed is:

1. A method for access-rate-based storage management of continuously stored data, comprising the steps of:
deciding an access weight dependent on an access rate for a data snapshot at a time point in the continuously stored data stored in a storage system;
determining whether the access weight reaches a first threshold and whether a full copy of the data snapshot at the time point is present in the storage system; and,
storing a full copy of the data snapshot at the time point into the storage system when the access weight reaches the first threshold and a full copy of the data snapshot at the time point is absent from in the storage system.

2. The method according to claim 1, further comprising the steps of:
determining whether the access weight reaches a second threshold and whether a full copy of the data snapshot at the time point is present in a data cache; and
storing a full copy of the data snapshot at the time point into the data cache when the access weight reaches a second threshold and a full copy of the data snapshot at the time point is absent from the data cache.

3. The method according to claim 1, further comprising the steps of:
receiving a request for accessing a data snapshot at a time point in the continuously stored data stored in the storage system; and
serving the access request.

4. The method according to claim 3, wherein the step of serving the access request comprises:
determining whether the data snapshot at the time point which is requested to be accessed is present in an access cache;
obtaining or restoring a full copy of the data snapshot at the time point from the storage system and loading it into the access cache when the determination result is No; and
serving the request for accessing the data snapshot at the time point using the loaded full copy of the data snapshot at the time point.

5. The method according to claim 4, wherein the access rate, access weight, first threshold and second threshold and storing location information of the data snapshot at the time point are maintained in a metadata base, and the determinations are made based on the information in the metadata base.

6. The method according to claim 3, wherein the step of serving the access request comprises:
determining whether the data snapshot at the time point which is requested to be accessed is present in an access cache;
further determining whether the data snapshot at the time point is present in the data cache when the determination result is No;
loading the full copy of the data snapshot at the time point from the data cache to the access cache when the further determination result is Yes;
obtaining or restoring a full copy of the data snapshot at the time point from the storage system and loading it into the access cache when the further determination result is No; and
serving the request for accessing the data snapshot at the time point using the loaded full copy of the data snapshot at the time point.

7. The method according to claim 1, wherein the access weight is equal to the access rate.

8. The method according to claim 1, wherein the continuously stored data stored in the storage system are in a form of full+differential copies.

9. The method according to claim 1, wherein the continuously stored data are CCMDB data or business data.

10. The method according to claim 1, further comprising the steps of:
collecting data from data sources; and
storing the collected data into the storage system as the continuously stored data.

11. The method according to claim 1, further comprising the step of adjusting the storage of data after the time point in the storage system based on the full copy of the data snapshot at the time point and a storage policy.

12. A system for access-rate-based storage management of continuously stored data, comprising:
a cache manager including:
a means for deciding an access weight dependent on an access rate for a data snapshot at a time point in the continuously stored data stored in a storage system;
a means for determining whether the access weight reaches a first threshold and whether a full copy of the data snapshot at the time point is present in the storage system; and,
a means for storing a full copy of the data snapshot of the time point into the storage system when the access weight reaches the first threshold and a full copy of the data snapshot of the time point is absent from the storage system.

13. The system according to claim 12, wherein the cache manager further comprises:
a means for determining whether the access weight reaches a second threshold and whether a full copy of the data snapshot of the time point is present in a data cache; and,
a means for storing a full copy of the data snapshot of the time point into the storage system when the access weight reaches the second threshold and a full copy of the data snapshot of the time point is absent from the data cache.

14. The system according to claim 12, wherein the cache manager further comprises:
a means for receiving a request for accessing a data snapshot at a time point in the continuously stored data stored in the storage system; and
a means for serving the access request.

15. The system according to claim 14, wherein the means for serving the access request further comprises:
a means for determining whether the data snapshot at the time point which is requested to be accessed is present in an access cache;
a means for obtaining or restoring a full copy of the data snapshot at the time point from the storage system and loading it into the access cache when the determination result is No; and
a means for serving the request for accessing the data snapshot at the time point using the loaded full copy of the data snapshot at the time point.

16. The system according to claim 15, wherein the access rate, access weight, first threshold and/or second threshold and storing location information of the data snapshot at the time point are maintained in a metadata base, and the determinations are made based on the information in the metadata base.

17. The system according to claim 14, wherein the means for serving the access request further comprises:
a means for determining whether the data snapshot at the time point which is requested to be accessed is present in an access cache;
a means for further determining whether the data snapshot at the time point is present in the data cache when the determination result is No;
a means for loading the full copy of the data snapshot at the time point from the data cache to the access cache when the further determination result is Yes;
a means for obtaining or restoring a full copy of the data snapshot at the time point from the storage system and loading it into the access cache when the further determination result is No; and
a means for serving the request for accessing the data snapshot at the time point using the loaded full copy of the data snapshot at the time point.

18. The system according to claim 12, wherein the access weight is equal to the access rate.

19. The system according to claim 12, wherein the continuously stored data stored in the storage system is stored in a form of full+differential copies.

20. The system according to claim 12, wherein the continuously stored data are CCMDB data or business data.

21. The system according to claim 12, further comprising:
a storage system configured to store continuously stored data;
a data manager configured to access the storage system; and wherein access to the continuously stored data in the storage system is carried out through the data manager.

22. The system according to claim 21, further comprising a data collector for collecting data from a data source; and wherein the data manager is further configured to store the collected data into the storage system as the continuously stored data.

23. The system according to claim 21, wherein the data manager is further configured to adjust the storage of data after the time point in the storage system based on the full copy of the data snapshot at the time point and a storage policy.
